(19) United States
(12) Patent Application Publication
(10) Pub. No.: US 2013/0060711 A1
(43) Pub. Date: Mar. 7, 2013

(54) TOOLBAR APPLICATION FOR ACCESSING VISUAL JOB INFORMATION

(71) Applicants: Michael Dachenhaus, Whitehouse, OH (US); Roger John Stanton, Geneva, IL (US); Young Jea Shin, Plainfield, IL (US)

(72) Inventors: Michael Dachenhaus, Whitehouse, OH (US); Roger John Stanton, Geneva, IL (US); Young Jea Shin, Plainfield, IL (US)

(21) Appl. No.: 13/666,715

(22) Filed: Nov. 1, 2012

Related U.S. Application Data
(63) Continuation-in-part of application No. 13/551,404, filed on Jul. 17, 2012.
Application No. 13/551,404 is a continuation-in-part of application No. 13/071,610, filed on Mar. 25, 2011.
(60) Provisional application No. 61/317,354, filed on Mar. 25, 2010.
(60) Provisional application No. 61/544,109, filed on Oct. 6, 2011.

(51) Int. Cl. G06Q 10/06

(52) U.S. Cl. 705/321

(57) ABSTRACT

A multimedia recruitment system for providing job information in a visual or video format is described. The multimedia recruitment system may deliver job and career opportunity information in a high quality visual or video representation. The multimedia recruitment system may also provide a toolbar application. The toolbar application may allow a user to access visual or video representation from the user's device.

### CROSS-REFERENCE TO RELATED APPLICATIONS

This application claims priority to, and the benefit of, U.S. Provisional Application Ser. No. 61/317,354, filed Mar. 25, 2010, for all subject matter common to both applications, and claims priority to, and the benefit of, United States Non-Provisional application Ser. No. 13/071,610, filed Mar. 25, 2011 also entitled System and Method for Providing Visual Job Information and Job Seeker's Information, all of which are incorporated herein by reference. This application also claims priority to, and the benefit of, United States Non-Provisional application Ser. No. 13/551,404, filed Jul. 17, 2012 also entitled System and Method for Providing Visual Job Information and Job Seeker's Information, all of which are incorporated herein by reference. This application also claims priority to, and the benefit of, U.S. Provisional Application Ser. No. 61/544,109, filed Nov. 1, 2011, which is incorporated herein by reference.

### FIELD OF THE INVENTION

The present disclosure relates to an automated process and associated computerized system for improving the recruitment process of qualified candidates for opened positions of different job postings, the process and system includes a platform for transforming information into a video posting displaying human and written video highlights based on the information, and more particularly to an online platform for uploading a text job opening and receiving an encoded video to embed in internet sites where job seekers can access the posting. In addition, this invention relates to an add-on toolbar connected to the system for generating and broadcasting Job Reports designed to help users of HTML-based browsers and other remote software to access, index, display, Job Reports and broadcast Job Reports to different external software including social media sites.

### BACKGROUND OF THE INVENTION

The present application relates to a system and method for providing job information to job seekers in a visual or video format and/or job seekers' information to employers in a visual or video format. In the conventional recruitment systems, employers post job information on the job board in a text-based format. The job seekers who apply for the job submit their resume and other information in a text-based format.

Many corporations have an ongoing flow of job openings to be filled by candidates and require an automated and simplified process for managing these job openings. Further, these corporations desire to reach a wider audience of potential job seekers and receive a larger proportion of well qualified and highly motivated applicants. As each job opening differs and the unique and necessary qualifications for each posting differ, it may be difficult for potential applicants to distinguish certain requirements that are essential to the opening from other requirements that are used to give a profile of what may be a good applicant.

In the pre-internet era, employers used newspapers ads to post new openings. A human resource manager would make an executive decision as to posting the publication in different newspapers, covering different geographical areas, and this manager would also decide the size of the posting and the font size for each requirement. Job seekers by looking at the ad and the newspaper reputation would get some type of information as to which requirement will be strictly observed, and which will be generally useful to obtain a position. Other types of venues for job postings included small job related publications, and local television channels offering wanted ad services. In each case the distribution of the job offer was limited in its potential to reach qualified candidates and distinguish between the essential job requirements from secondary job requirements.

Today with the arrival of the internet and other types of online or wireless communications, job seekers are bombarded with text-based job descriptions. In this fluid format of information, it may be very difficult to distinguish between essential job requirements and secondary job requirements, it is also difficult to distinguish between important ads posted by employers and less important ads as these may be posted side by side on a board or list.

Finally, in the field of broadcast, publishing, and media edition, the authorship of a book, a pilot, or even a video clip created using any automated system is only the first part of the process. Even the best book may fail unless it reaches the intended audience and is distributed to an audience in such a way and time as to achieve the desired result. What is desired are improvements associated with a system for providing visual or video format information to potential job seekers.

Recently, with the development of the internet, other social media software such as Twitter, Facebook and the like have gained in popularity. The growth of these types of online applications is only expected to grow in the next decades. Many users of the Internet have become accustomed to the use of a single remote browser interface at the user point of access of the information. Users no longer desire to upload and install on their computer independent executable software in executable format.

One of the ways to transfer information is to force third party software and websites to embed the Job Reports and other functionalities into their own pages. For example, an airline provider who has opened jobs to be filled and receives Job Reports produced by the System for producing Job Reports, can manage these via links or storage. What is needed is an additional way for the airline provider to offer these Job Reports to browsers of the site without the need to actively include or merge this data into their platform.

New technology, like iPads and larger phone displays are used primarily through a single browser interface to navigate the web. The installation of independent and autonomous software on these devices is made more rigorous since they do not include hard drives, ports or other connectors to obtain the software. These devices must rely on the browser interface to upload external software making this step rather time consuming. What is needed is a way to offer the full functionality of the System for producing Job Reports to browsing interfaces. Further, what is needed is a new way to offer the functionalities and Job Reports to a user from any website surfed using the browser interface.

### BRIEF SUMMARY OF THE INVENTION

An exemplary embodiment of the present application is a multimedia recruitment system for delivering job and career opportunity information in a visual or video format to potential job seekers. The exemplary embodiment automatically converts text-based job descriptions provided by employers and/or recruiters relating job openings, into a high quality visual or video representations (“Job Reports”).

The Job Reports are then distributed to job seekers through a plurality of media including for example television (“TV”) channels or networks, on-line communication networks, wireless networks, etc. The exemplary embodiment provides a new recruitment system that brings the power of video and the convergence of media to the employers as well as to the job seekers.

An exemplary embodiment may provide job seekers or job candidates' information in a visual or video format. Unlike the conventional text-based resume, the exemplary embodiment may generate visual or video representations (“Video Introductions”) of the job seekers or job candidates' information. The exemplary embodiment may enable the job seekers or job candidates to submit their Video Introductions to employers through TV channels or networks, on-line communication networks, wireless networks, etc. The employers can reduce a screening process using the Video Introduction.

In another exemplary embodiment, the system designed to create Job Reports also allows for administrators to use the platform to broadcast widely the information to customized client web pages, a basic web portal managed by the system, external pages found on different external web pages such as social web sites, and to web pages of partners also engaged in distribution of related content. The system also allows for client customization of client web pages, distribution to external web pages of the choosing of the client, and to any other web page.

The current invention provides how the system for generating the Job Reports and for the use, display, and broadcast of the Job Reports includes a software stand alone tool, to be uploaded by a user on a remote hardware as a toolbar having a number of functions that allow the user of a software browser at the user platform to constantly have access to the System for Generating Job Reports, have easy indexed access to Job Reports and to interact with the system as if the user was logged in the platform. Further, the toolbar may include tools to publish and rebroadcast the Job Reports to third party software like for example Social Media platforms. The toolbar application allows the users to access their video assets without requiring the migration away from other Software as a Service (SAAS) applications.

### BRIEF DESCRIPTION OF THE DRAWINGS

FIG. 1 is a screen shot of a frame from a Job Report in an exemplary embodiment;

FIG. 2 is a screen shot of an exemplary contact information page displayed at the end of the exemplary Job Report as shown at FIG. 1;

FIG. 3 is a screen shot of a different frame from the Job Report shown at FIG. 1 in which an on-air talent interviews a company executive or a recruiter to deliver job information and/or company information;

FIG. 4 is a flow chart showing the interactions between an employer and a multimedia recruitment system used as part of the recruitment system to generate the Job Report shown at FIG. 1 in an exemplary embodiment;

FIG. 5 is a diagram showing how the a script and the graphic form are input to a teleprompter and a character generator as part of the multimedia recruitment system;

FIG. 6 is a diagram of portions of the multimedia recruitment system shown at FIG. 4 used to generate a Job Report as shown at FIG. 1 in an exemplary embodiment;

FIG. 7 is a diagram showing the distribution of the Job Report of FIG. 1 to TV channels in an exemplary embodiment;

FIG. 8 is a diagram showing the distribution of the Job Report of FIG. 1 in a Job Video .FLV format and ultimately posted on an exemplary website in an exemplary embodiment;

FIG. 9 is a diagram showing the distribution of the Job Report of FIG. 1 as posted on a mobile friendly website in an exemplary embodiment;

FIG. 10A is a block diagram showing a server side application and a client side application running on a multimedia recruitment system and a user device, respectively, in an exemplary embodiment;

FIG. 10B is a flow chart showing an exemplary operation between the server side application and the client side application depicted in FIG. 10A;

FIG. 10C is an exemplary presentation side showing how a toolbar application works in an exemplary embodiment;

FIG. 10D is another exemplary toolbar provided in an exemplary embodiment;

FIG. 10E is an exemplary window displayed by the Login button depicted in FIG. 10D;

FIG. 10F is an exemplary window displayed by the New User link depicted in FIG. 10E;

FIG. 10G is an exemplary window displayed when a user successfully logged in;

FIG. 10H is an exemplary window displayed by the Company button depicted in FIG. 10D;

FIG. 10I is an exemplary window displayed by the Job Video button depicted in FIG. 10D;

FIG. 10J is an exemplary preview provided by the Job Report hyperlink depicted in FIG. 10I;

FIG. 10K is an exemplary window displayed by the Share link in the preview shown in FIG. 10J;

FIG. 10L is an exemplary window displayed by the Cultural Insight Video button depicted in FIG. 10D;

FIG. 10M is an exemplary preview provided by the Cultural Insight hyperlink depicted in FIG. 10L;

FIG. 10N is an exemplary window displayed by the Share link from the preview shown in FIG. 10M;

FIG. 11 is an exemplary network environment suitable for implementing an exemplary embodiment; and

FIG. 12 depicts exemplary computing device suitable for practicing an exemplary embodiment.

### DETAILED DESCRIPTION OF THE INVENTION

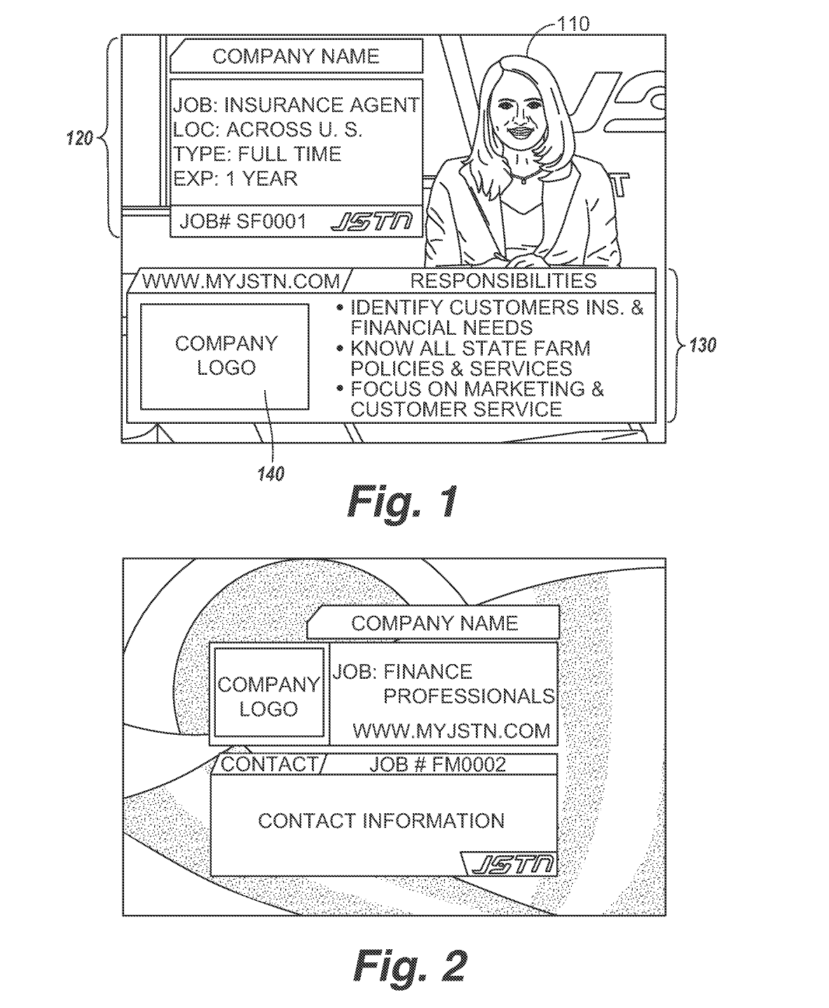

As shown at FIGS. 1-12, this invention relates to a multimedia recruitment system for providing and transforming job related information in a visual or video format and for generating a visual or video representation of this information in what is referred to as a Job Report and an associated toolbar application to help merge data into third party sites. A text-based job description is received from an employer and/or a recruiter and in turn this description is used to generate a visual or video representation associated with the job description.

The invention provides a multimedia recruitment system for providing to a job seeker or a job candidate information in a visual or video format relating to a job opening. In addition, the multimedia recruitment system also provides to the job seeker or the job candidate a tool for generating a visual or video representation of the job seeker or job candidate's information back as a response to the Job Report. The visual or video representation of the job seeker or the job candidate with personal information sufficient to answer the job opening is referred to as a Video Introduction.

The visual or video format or representation may include at least a series of image or picture frames for a predetermined time period or duration. The visual or video representation may be provided in a wide range of video formats, which use different COmpressors-DECcompressorS (CODECS) to encode and compress video data. The possible contemplated video formats include, but are not limited to, 0.3GP (3GPP Multimedia File), .FLV (Flash Video File), .MPG (MPEG Video File), .WMV (Windows Media Video File). The visual or video representation may also include an audio stream of data.

Description of the Job Report

FIG. 1 is a screen shot of one of the frames of an exemplary Job Report. The invention generates for example a Job Report that is specific and customized to an individual job opening. The Job Report may have a predetermined fixed length of time or a variable length of time depending on the job description provided by an employer. For example, the Job Report may be 30 seconds in length. In the Job Report, the job description may be as shown partly delivered by an on-air talent 110 in a network news style. While one type of delivery is shown, one of ordinary skill in the art will appreciate that other types of delivery styles aside from the network news style may be used.

The on-air talent 110 may first introduce a job listing while relevant position information is displayed as shown at 120, 130 on the side and/or bottom of the screen as shown. The Job Report may contain the employer or company's logo 140 and key statistics about the company and the job positions available. In the background, as shown, the logo of a third party offering services associated with the production of Job Reports (i.e. JSTN) may be displayed in the back, on the relevant positions 120, 130.

The Job Report as shown at FIG. 1 may include several graphic areas 120 and 130 displayed at different portions of the screen. In the example shown at FIG. 1, one of the two graphic areas is located on left side of the screen, and the second graphic area is located on the bottom of the screen. The first graphic area 120 may be provided at the left upper corner of the screen. The graphic area may display information such as an employer's name, a job title for the position, a job location for the position, a job type, a required experience/education level and a unique job number.

The second graphic area 130 as shown may be provided at the bottom area of the screen. In the second graphic area 130, different information may be displayed in sequence or even scrolled as for stock or live news tickers. For example, an employer information may be displayed next to other important information 130. This information may include benefit information, the responsibilities of the position, and then the qualifications of the position. This area 130 may include a single or a plurality of lines for the display the this information. As shown, the second graphic includes three lines each with up to 45 characters. The employer's logo 140 may be displayed in the second graphic area. While one possible configuration of information display is shown, what is contemplated is the use of any known techniques to display as an overlay over an anchor the information.

FIG. 2 illustrates a screen shot of a job and contact information page generally reserved for the end portion of the Job Report. On FIG. 2, at the top of the screen, an employer name, an employer's logo and a job title is be displayed. At the bottom of the screen, the employer's contact information, a job identification number and a disclaimer is displayed. Once again, as shown the logo of a third party service provider may be imbedded within these images to help give every Job Report describing jobs from a large number of different potential employers an overall look and feel. While one possible display of information is shown, what is contemplated is the display of information in any number of configurations.

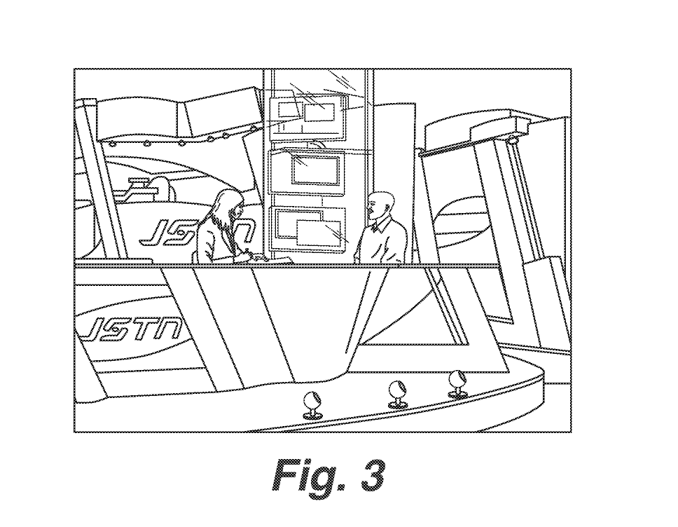

FIG. 3 shows a screen shot of an exemplary Job Report from a different camera angle in which an on-air talent 110 interviews a company executive or a recruiter to help deliver some of the company information. During the interview, the company logo may be displayed on the background of the Job Report or it may be placed in different areas around the display area. While FIG. 3 shows one possible different camera angle or method of display of the information using external actors or other sources of information, what is contemplated is the use of any incrustation of video, or information in any format known in the news industry. In addition to inputting the graphic form into the character generator, the second video includes information selected from a group consisting of a film of an external actor, incrustation of a video, information from the news industry.

The Production of a Job Report

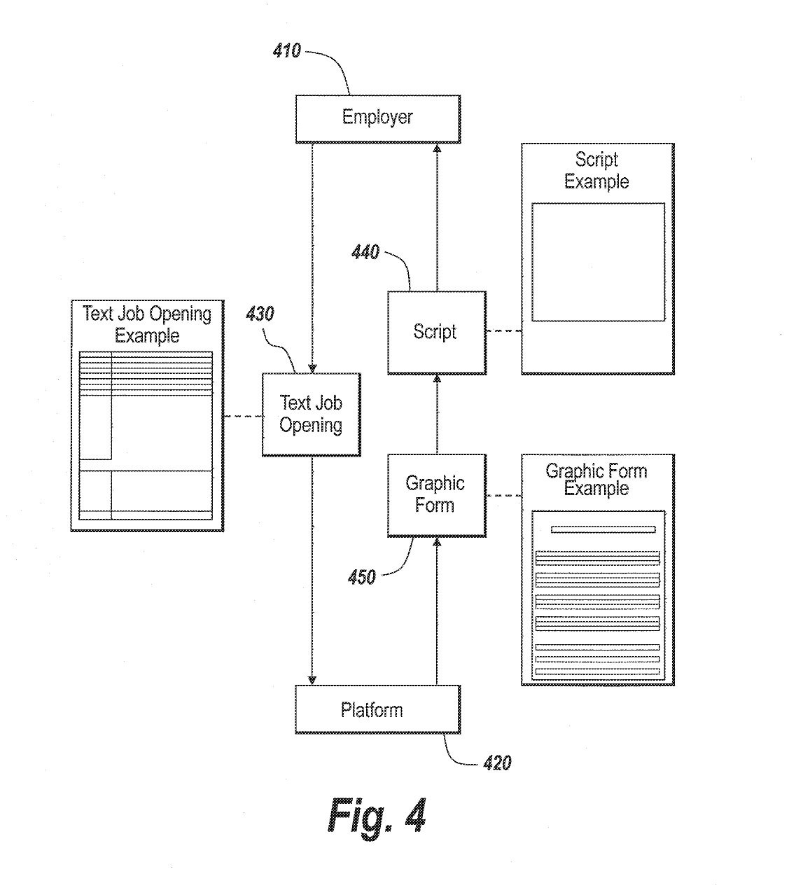

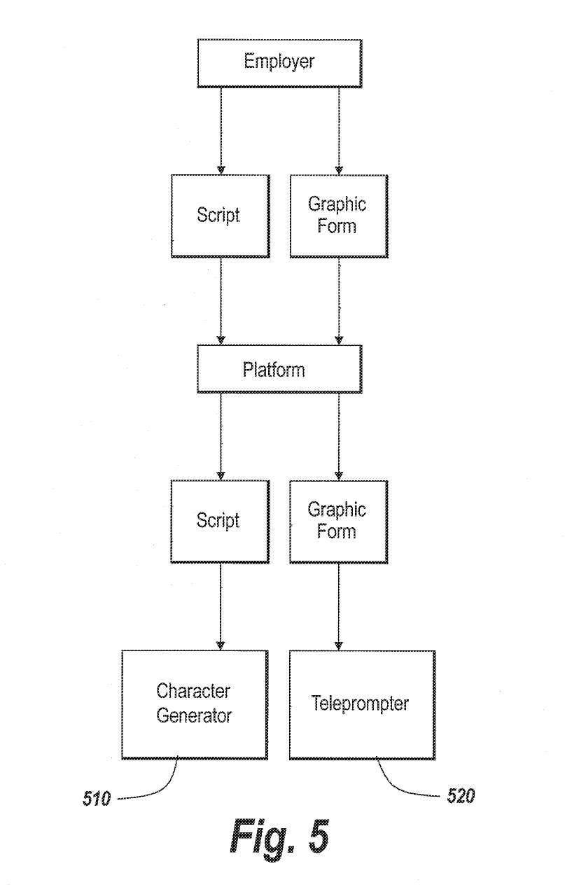

FIG. 4 is a flow chart showing the interactions between an employer 410 who must fill a job vacancy and the multimedia recruitment system shown here as a platform 420 to produce a Job Report as shown at FIG. 1. An employer provides a text-based job description 430, and in an alternate embodiment, the employer the employer uploads the text-based job description 430 using a pre-populated form in a text editor format and more precisely using an online web form. The multimedia recruitment system 420 can also generate a script 440 for the on-air talent 110 to read out loud using a teleprompter 520 as shown at FIG. 5 and to be incorporated as part of the Job Report shown at FIG. 1. The script 440 is then sent in some embodiments back to the employer 410 for approval (as illustrated by the arrow). As illustrated at FIG. 4 in a page drawn with the label ‘script example,’ the script 440 is text to be read out loud by one or several actors as part of the Job Report.

At the same time, the multimedia recruitment system 420 may generate and send graphic forms 450 directly for processing as shown at FIG. 5 or for the employer 410 to fill out. The graphic forms 450 are text to be displayed on the screen of the Job Report as discussed above with reference to FIG. 1. After the employer 410 approves the script 440 and alternatively also fills out the graphic form 450 if one is generated, the employer 410 returns the script 440 and the graphic form 450 to the multimedia recruitment system. These exchanges of information between the employer 410 and the platform 420 also the recruitment system for generating a Job Report are designed to be optimized and minimized in size and volume. Employers 410 often look for many closely related candidates and the different scripts 440 and graphic forms 450 will be closely related as the text job opening 430 will also be extremely similar (e.g. two engineers may have only the level of experience different). By using forms and validation steps as part of this process, the employer 410 and the platform 420 can be programmed to generate the different intermediate documents 430, 440 and 450 in less time and effort.

FIG. 5 is a diagram showing how the script 440 from FIG. 4 is input to the teleprompter 520 to be read out-loud by the talent 110 as shown at FIG. 1. The graphic forms 450 are in turn input to a character generator 510 in the multimedia recruitment system as shown at FIG. 4. The multimedia recruitment system 420 may include the character generator 510 and the teleprompter 520. FIG. 5 shows how once the employer 420 has approved both the script 440 and the graphic form 450, the employer 410 can provide the script 440 and the graphic form 450 to the platform 420 also described as the multimedia recruitment system and both of these documents are in turn sent to two elements 510 and 520 that can also be considered part of the platform 420 that are useful external tools to generate the Job Report. In an alternate embodiment, the character generator and the teleprompter 510, 520 are internal to the multimedia recruitment system but external to the platform 420.

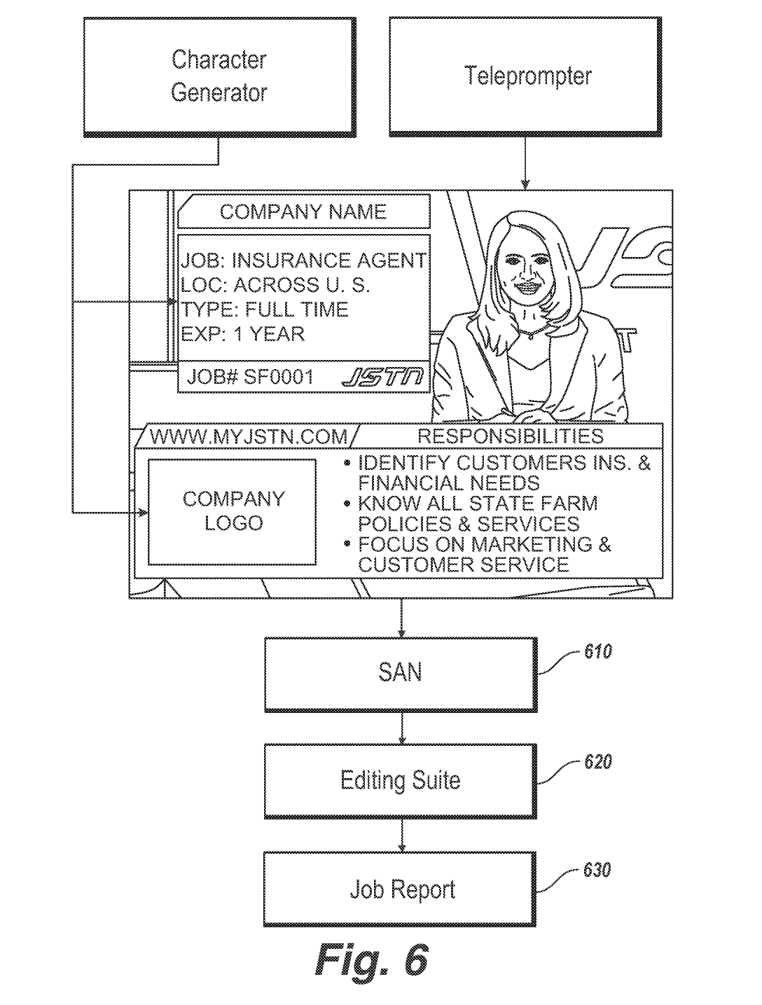

FIG. 6 is a diagram of an exemplary multimedia recruitment system that generates a Job Report with a third portion of the entire process illustrated in full by FIGS. 4-6. When the multimedia recruitment system 420 produces a Job Report, the multimedia recruitment system feeds the graphic information from the character generator and the script to a teleprompter while taping. The Job Report with graphic areas and the Job Report without graphic areas are recorded in the video tape recorders as well as captured in the Quicktime video format, which is known as .MOV file. The .MOV files are stored in the Storage Area Network (SAN) 610. The video clips with graphic areas are edited in the editing system 620 to produce a predetermined length of a Job Report 630.

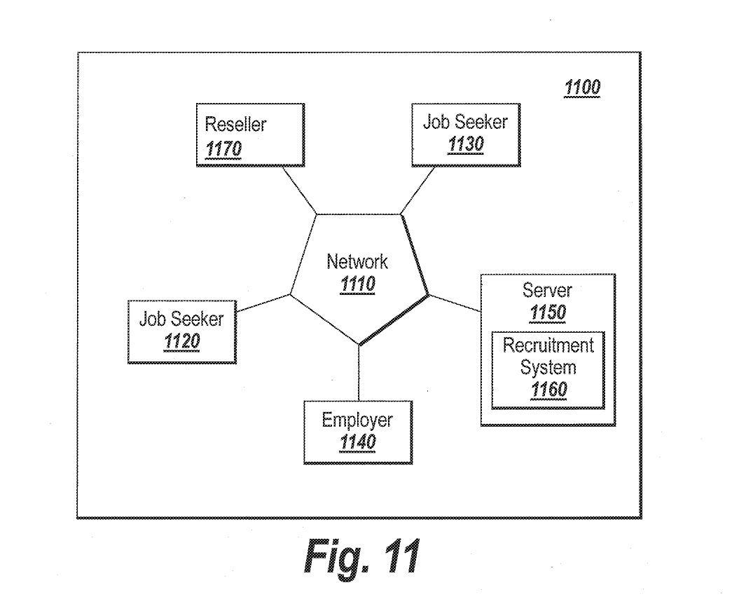

What is described is a recruitment system 420 for generating a Job Report as shown in FIG. 1 in a network environment as described in FIG. 11. The recruitment system 420 includes a server 1150 as shown at FIG. 11 to house the recruitment system 420 coupled as shown to a plurality of job seeker devices 1120, 1130, and 1170 and at least an employer device 1140 via a communication network 1110.

In the system 420, an employer 410 uploads using the employer device 1140 a text-based job description 430 relating to a job opening to the server 1150 via the communication network link 1110 between the employer device and the server (shown by lines between the units). The server 1150 includes a multimedia requirement system 1160 also shown as 1200 for the production of a Job Report produced by transforming the text-based job description 430 using a platform 420 into a script 440 and a graphic form 450 by inputting the script 440 into a teleprompter 520 to be read by an on air talent 110 and recorded using a camera (not shown) as a first video. Further, the system 420 produces the Job Report as shown at FIG. 1 by inputting the graphic form 450 into a character generator 510 for producing a second video and by storing the first and second videos in a storage area network 610 as shown at FIG. 6.

Finally, the system 420 also allows for editing the first and second videos using an editing suite 620 to produce with both the first and second videos the Job Report as shown at FIG. 1. The Job Report as shown at FIG. 11 can be viewed by at least a job seeker using one of the plurality of job seeker devices 1120, 1130, and 1170 over the communication network 1110 from the server 1150.

In another embodiment, Job Report is uploaded by the employer 410 using the employer device 1140 from the server 1150 and the Job Report is viewed on a employer website instead of the server 1150 after being uploaded in a video format and merged into an HTML web page.

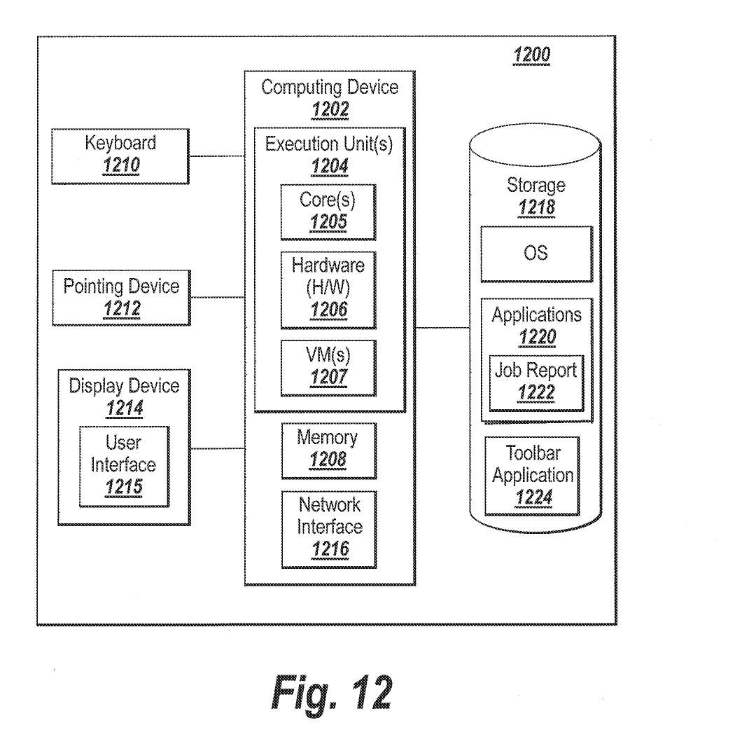

What is also contemplated and described is a method for producing a Job Report as shown at FIG. 1. The method is performed by conducting using the hardware as described above the steps of (a) uploading a text-based job description 430 relating to a job opening in a multimedia requirement system 420 using an employer device 1140 connected to a server 1150 hosting the multimedia requirement system 1160. The multimedia requirement system 1160 as shown at FIG. 12 can be located in a computing device 1202 with an execution unit 1204, a memory 1208, and a network interface 1216 in communication with a storage 1218.

The next step is to transform the text-based job description 430 using the platform 420 into a script 440 and a graphic form 450, and then inputting the script 440 into a teleprompter 520 to be read by an on air talent 110 and recorded using a camera (not shown) as a first video. The next step is the input of the graphic form 450 into a character generator 510 for producing a second video, and finally storing the first and second videos in the storage 610 and editing the first and second videos 620 to produce a Job Report.

Other possible steps include having at least one of a plurality of job seekers through their own devices uploading the Job Report on a job seeker device 1120, 1130, and 1170 connected to the multimedia requirement system 420. The Job Report can also be viewed using a video streamer from a web-based interface, and using a review step as part of this method.

Distribution of Job Report

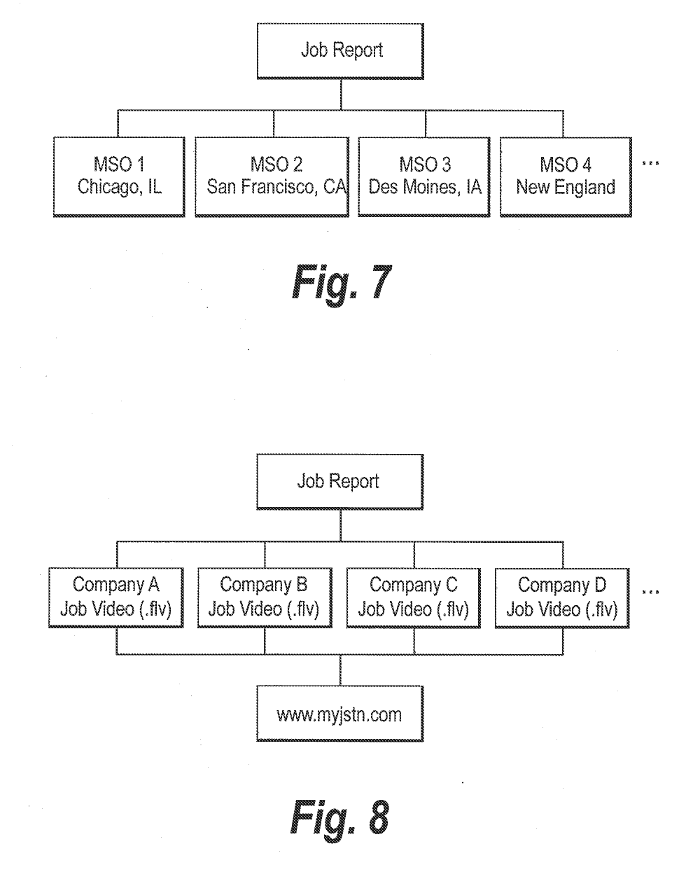

FIG. 7 is a diagram showing how the Job Report is distributed to those who broadcast the Job Reports via TV channels or networks. Once the Job Report is produced, the multimedia recruitment system prints out the Job Report on the video tapes and distributes the video tapes to dedicated market MSOs (Multiple System Operators), such as Comcast, Time Warner, Cox and Mediacom, etc. The Job Reports are broadcasted via the TV channels or networks. In an embodiment, the Job Report may be distributed using a satellite or an optical fiber.

FIG. 8 is a diagram showing that the Job Report is posted on a website in an exemplary embodiment. The multimedia recruitment system may transfer each Job Report into a Flash Video File, which is known as .flv files, and send the .flv files to the website to post the Job Report on the website.

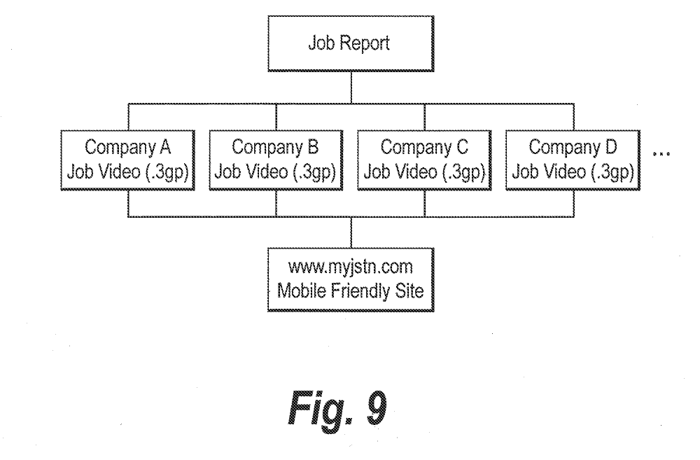

FIG. 9 is a diagram showing that the Job Report is posted on a mobile friendly website in an exemplary embodiment. The multimedia recruitment system may transfer each Job Report into mobile phone video file, which is known as 0.3gp, to post the Job Report on a mobile friendly site. The Job Report can be viewed on the mobile phone, which can access the mobile friendly site.

An exemplary embodiment provides a toolbar for users to directly access video assets stored in the multimedia recruitment system. The video assets may include Job Reports. The toolbar may be integrated with the users' browser applications so that the users can access the access video assets without requiring the migration away from other Software as a Service (SAAS) applications.

Toolbar Application

The toolbar application may provide client users with direct access to their stored video assets, such as Job Reports, within the recruitment server system, without requiring the migration away from other SAAS applications.

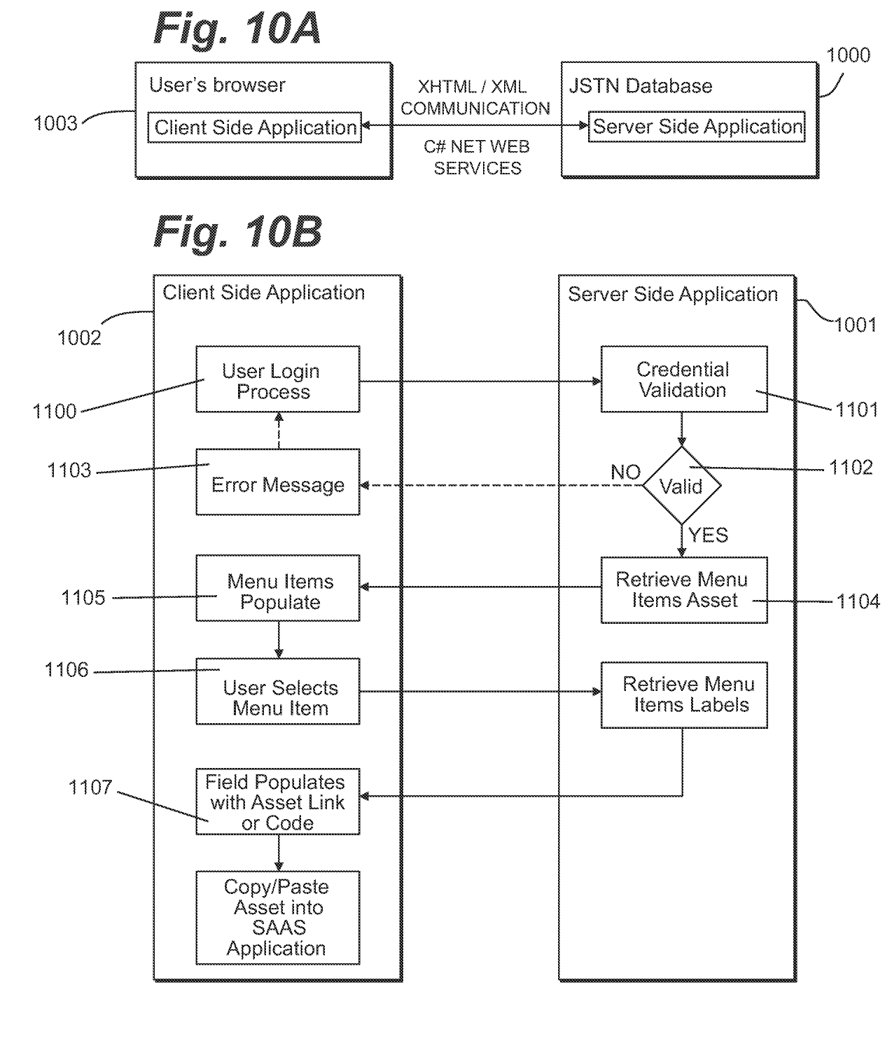

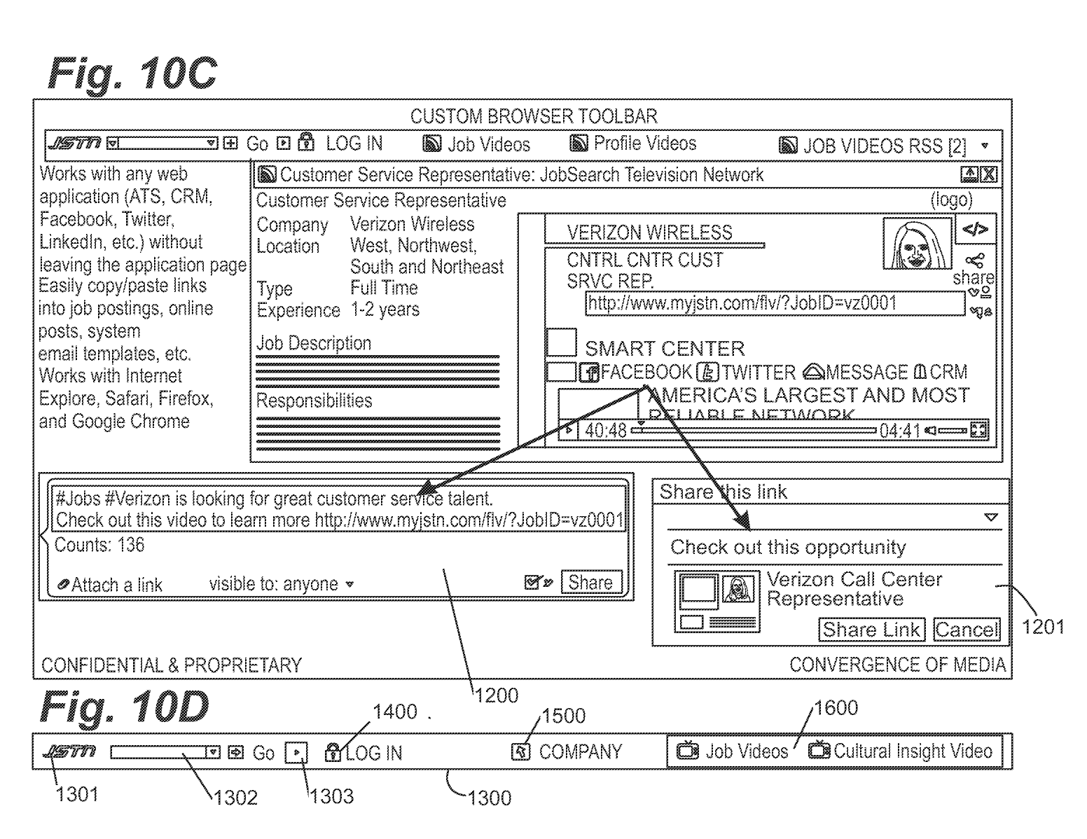

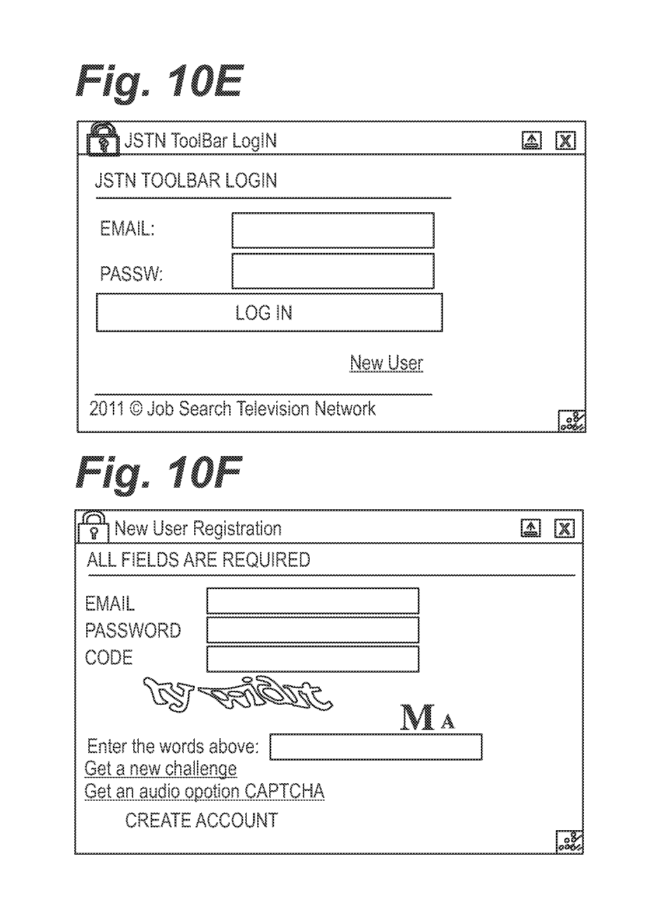

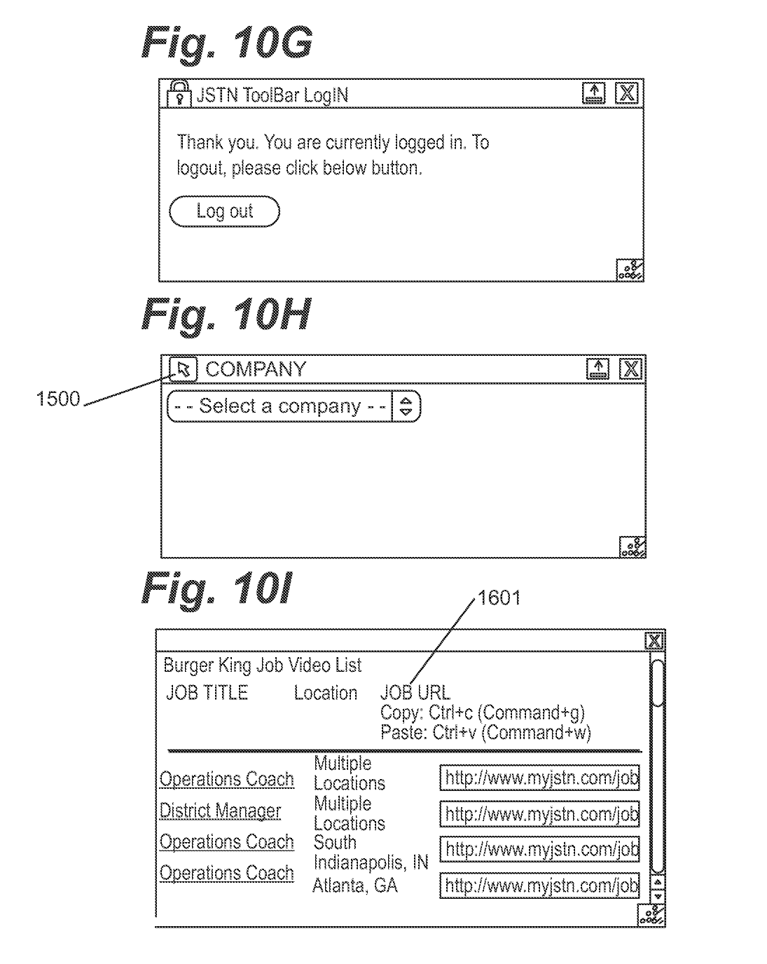

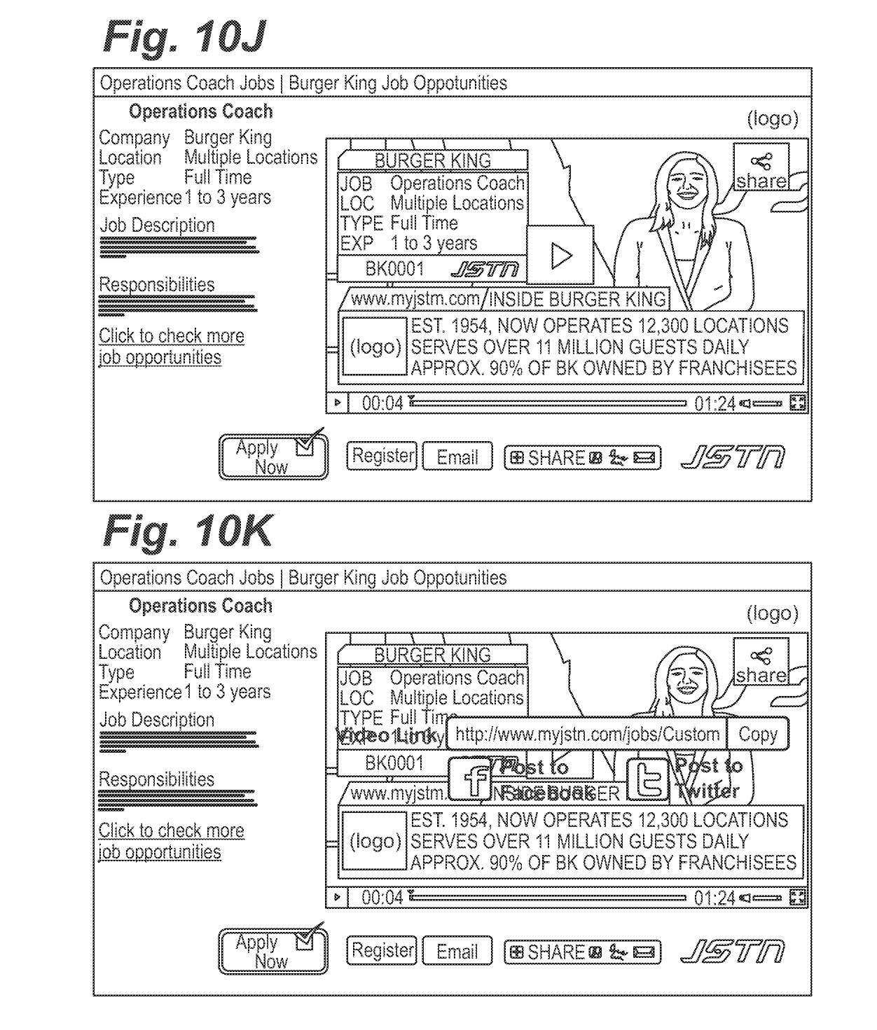

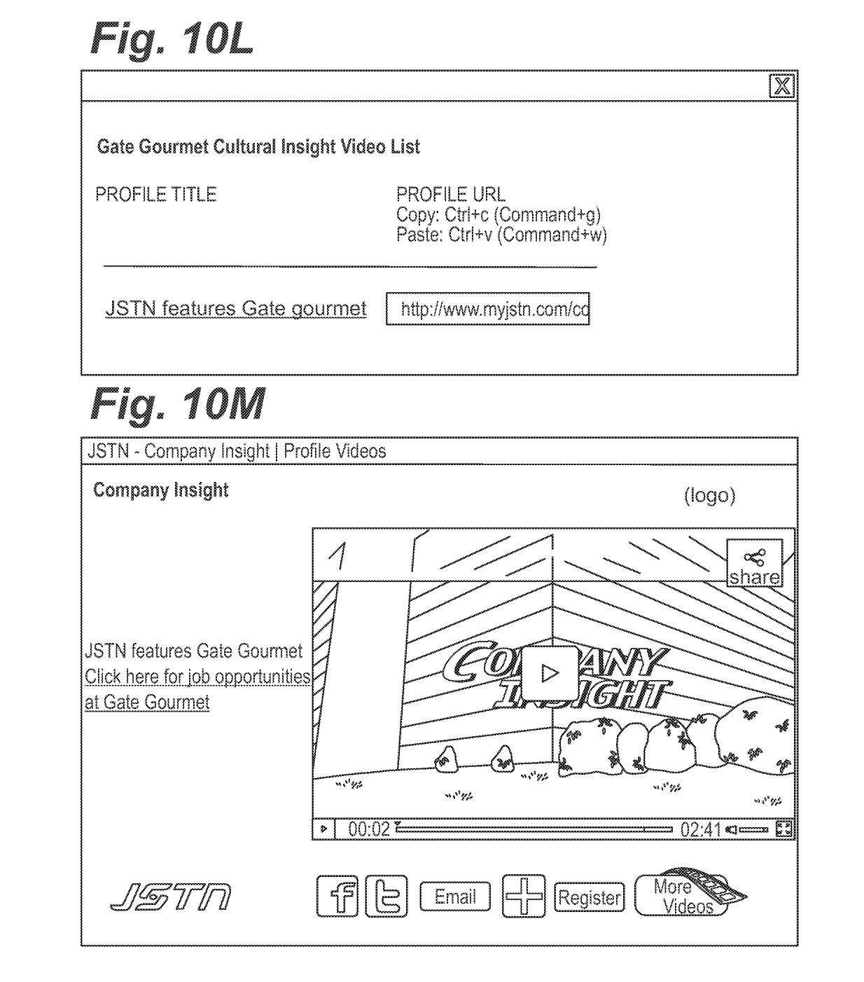

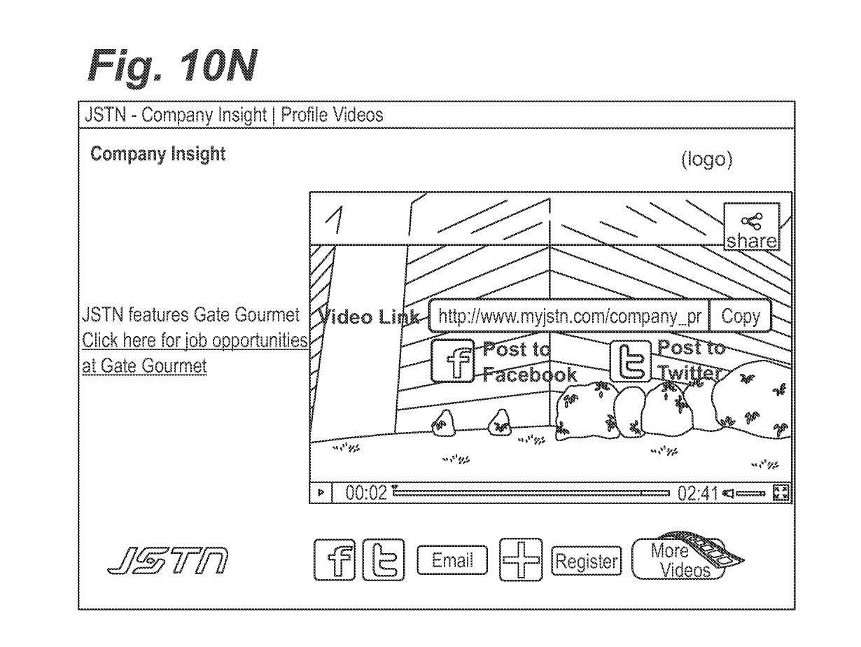

FIG. 10A is a block diagram showing a server side application and a client side application running on a multimedia recruitment system and a user device, respectively, in an exemplary embodiment. There are two parts to the toolbar application, a first is software on the Database 1000 operating a Server Side Application 1001, with for example access through C# .NET web services to the MySQL databases of the recruitment system where Job Reports are stored or indexed. Data is delivered from the server to the client via XHTML I XML feeds or any other type of data transfer protocol, the most common being XML for use by an HTML compatible browser on the client or user side.

A Client Side Application 1002 operates in a user browser 1003. In one embodiment, the Client Side Application 1002 is the tool bar application described below, built on the on a platform such as for example the platform called Conduit™ accessible over the Internet at the web domain conduit.com. The Conduit platform is for example downloaded and installed on the user's device, and running as a part of the Internet browser or can be attached to any software uploaded on the client side application 1002 from the server side 1001.

One of ordinary skill in the art will recognize that each user browser 1003 is different technology, model, and includes different functions that must be relied upon to make any tool-bar offered and located on the server or another website. For example, the server website may have HTML pages where information can be accessed. On this page, information as to what steps must be taken, which browser versions are adapted for each version of the tool-bar to be uploaded and that level of technology is supported. today, Mac and PC systems are highly different and different links and associated versions of the tool-bar must be offered for upload at the client side.

What is also described as a ‘tool-bar’ in addition to its ordinary definition includes any type of macro, software patch, engine, pop-up menu, utility, that will be connected dynamically with the browser of the user as it is used. For example, the Facebook™ social media interface includes its own programming language, its own tools to program, and obligations that the browser remain in the same page. A ‘tool-bar’ in the Facebook™ interface is understood to be any programming patch that can be uploaded by a user from the browser to enhance the Facebook experience and/or page to give additional capacities explained below.

FIG. 10B is a flow chart showing an exemplary operation between the server side application and the client side application depicted in FIG. 10A. Client users may download and install the toolbar that runs as an application within their Internet browser on the local computer. A login/credentialing process is included as a part of the toolbar menu. Client users will login to the recruitment system through the toolbar using a combination of company id, username, and/or password. Once login has been validated by the systems, the toolbar menus may populate with client specific video asset data. Data may include links to Job Reports, cultural insights, and other resources that may simplify the process of sharing video assets via web based (SAAS) applications through simple a simple copy/paste process.

As shown at FIG. 10B, the Client Side Application 1002 includes a first step 1100 of a user login process where a person/user enters information as shown at FIGS. 10E to 10G. On the server side 1001, the information entered at step 1100 is then validated 1101 when indexed in a database (not shown). The server than matches the information with the data in the database to see if the user can be verified as illustrated 1102. If in case the user is not recognized, the system will prompt a new a new entry via an error message 1103.

Once the user is verified the different menus and labels are retrieved 1104 from the server and sent to the user browser for display where each menu in a subsequent step is populated 1105. Then, via the Client Side Application 1002, the user selects and retrieve a menu item 1106 of interest in the toolbar displayed on his/her browser.

The server side 1001 then sends data 1107 like for example an access link or a data code (as described below) for use by the user.

FIG. 10C is an exemplary showing how a toolbar application works in an exemplary embodiment. The toolbar application may be integrated in web browsers, such as Safari, Google Chrome, Internet Explorer®, Firefox, etc. The toolbar application may work with web applications, such as ATS, CRM, Facebook, Twitter, Linked in®, etc., without leaving the application page. The toolbar enables users to copy/past links into job postings, online posts, system email templates, etc.

In FIG. 10C, a web designer, a web user that represents a corporate client willing to help with the broadcast of job openings and associated Job Reports produced by the system will need special data to be inserted in different HTML pages or other data that can be used by social sites. For example, the figure shows the generation of a code for tweeter 1200 or for Facebook 1201. As shown, a user will be given simple icon selection 1202, 1203 as part of the toolbar.

FIG. 10D is an exemplary tool bar provided in an exemplary embodiment. The toolbar 1300 includes a logo 1301, a search bar 1302 and search launch button 1303, a login button 1400, a company selection tab 1500, and some quick accesses for the database 1600 and the associated videos.

The login button 1400 will then prompt a small data entry page as shown at FIG. 10E is an exemplary window displayed by the Login button depicted in FIG. 10D. FIG. 10F is an exemplary window displayed by the New User link depicted in FIG. 10E. FIG. 10G is an exemplary window displayed when a user successfully logged in.

The access login as shown can be done using any interface, but generally one that includes a security alienation such as a word entry visual recognition algorithm or some other password, code word, or data.

FIG. 10H is an exemplary window displayed by the Company button depicted in FIG. 10D. This may allow resellers to access video assets across their client database. The button 1500 is part of the toolbar shown at FIG. 10D.

FIG. 10I is an exemplary window displayed by the Job Video button depicted in FIG. 10D. A link 1601 is given for each of the Job Reports found in the server database. A user will simply ‘cut & paste’ the link provided into codes of source code being programmed or in locations recognized by browsers or other applications to generate a page where the video or Job Report will play. The users may copy and paste the video link or preview video through the hyperlink.

FIG. 10J is an exemplary preview provided by the Job Report hyperlink depicted in FIG. 10I. FIG. 10K is an exemplary window displayed by the Share link in the preview shown in FIG. 10J. The users may copy and paste the version of a video link. It may be the same as displayed in initial Job Video window.

FIG. 10L is an exemplary window displayed by the Cultural Insight Video button depicted in FIG. 10D. The users may copy and paste the videolink or preview video through the hyperlink. FIG. 10M is an exemplary preview provided by the Cultural Insight hyperlink depicted in FIG. 10L. FIG. 10N is an exemplary display provided by the Share link from the preview shown in FIG. 10M. The users may copy and paste the version of a videolink. It may be the same as displayed in initial Job Video window.

Generally, what is described above is a system for generating a Job Report and distributing the Job Report in a network environment, the recruitment system comprising a server coupled to a plurality of job seeker devices and at least an employer device via a communication network, where an employer uploads using the employer device a text-based job description relating to a job opening to the server via the communication network link between the employer device and the server, where the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and where a link associated with the Job Report is uploaded by a user of a browser having a toolbar application using the toolbar for the installation of the link on a source code of a webpage for the imbedded broadcast of the Job Report to a job seeking viewing the webpage.

Further, the link can be a HTML code to be embedded in an HTML webpage, the link can be data to be inserted in social media sites. wherein the HTML webpage is a website on the Internet. Also, the website can be a job opening webpage of the employer.

Also described is a toolbar for use by a system for generating a Job Report and distributing the Job Report in a network environment, the system comprising: a server coupled to a plurality of job seeker devices and at least an employer device via a communication network, where an employer uploads using the employer device a text-based job description relating to a job opening to the server via the communication network link between the employer device and the server, where the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and where the toolbar includes a login authentication, a search bar, and at least a selection tab.

Finally, what is also contemplated is a method for imbedding a Job Report in a webpage of an employer having a job to be filled, the method using a toolbar for use by a system for generating the Job Report, the system including a server coupled to a plurality of job seeker devices and at least an employer device via a communication network, wherein an employer uploads using the employer device a text-based job description relating to a job opening to the server via the communication network link between the employer device and the server, wherein the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and A toolbar wherein the toolbar includes a login authentication, a search bar, and at least a selection tab, the method includes the steps of: installing the toolbar at the employer device, authentication of the user, using the selection tab to select at least a Job Report produced by the system, generating by the system of a link associated with the Job Report, and imbedding into a HTML code the link for display of the Job Report when a browser displays the HTML code with the embedded link. The method can also include the step of allowing a job seeker to view the HTML code.

Exemplary embodiments are described above. It is, however, expressly noted that these exemplary embodiments are not limiting, but rather the intention is that additions and modifications to what is expressly described herein also are included within the scope of the present implementation. Moreover, it is to be understood that the features of the various embodiments described herein are not mutually exclusive and can exist in various combinations and permutations, even if such combinations or permutations are not made express herein, without departing from the spirit and scope of the present implementation.

Since certain changes may be made without departing from the scope of the present implementation, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present implementation and that the illustrations contained herein are singular examples of a multitude of possible depictions of the present implementation.

1. A system for generating a Job Report and distributing the Job Report in a network environment, the recruitment system comprising:
a server coupled to a plurality of job seeker devices and at least an employer device via a communication network,
wherein an employer uploads using the employer device a text-based job description relating to a job opening to the server via the communication network link between the employer device and the server,
wherein the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and
wherein a link associated with the Job Report is uploaded by a user of a browser having a toolbar application using the toolbar for the installation of the link on a source code of a webpage for the imbedded broadcast of the Job Report to a job seeking viewing the webpage.

2. The system of claim 1, wherein the link is a HTML code to be embedded in an HTML webpage.

3. The system of claim 1, wherein the link is data to be inserted in social media sites.

4. The system of claim 2, wherein the HTML webpage is a website on the Internet.

5. The system of claim 4, wherein the website is a job opening webpage of the employer.

6. The system of claim 1, wherein the toolbar includes a login button for authentication.

7. The system of claim 6, wherein the toolbar further includes a feature from a group consisting of a logo, a search bar, a search launch button, a company selection tab, and a quick database access.

8. A toolbar for use by a system for generating a Job Report and distributing the Job Report in a network environment, the system comprising:
a server coupled to a plurality of job seeker devices and at least an employer device via a communication network,
wherein an employer uploads using the employer device a text-based job description relating to a job opening to the server via the communication network link between the employer device and the server,
wherein the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and
wherein the toolbar includes a login authentication, a search bar, and at least a selection tab.

9. The toolbar of claim 8, further comprising means to generate a link associated with the Job Report.

10. The toolbar of claim 9, where the toolbar is installed on the employer device.

11. The toolbar of claim 10, wherein the link generated by the toolbar is for embedding the Job Report in an HTML source code of an HTML page on the website of the employer.

12. A method for imbedding a Job Report in a webpage of an employer having a job to be filled, the method using a toolbar for use by a system for generating the Job Report, the system including a server coupled to a plurality of job seeker devices and at least an employer device via a communication network, wherein an employer uploads using the employer device a text-based job description relating to a job opening to the server via the communication network link between the employer device and the server, wherein the server includes a multimedia requirement system for the production of a Job Report produced by transforming the text-based job description using a platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and A toolbar wherein the toolbar includes a login authentication, a search bar, and at least a selection tab, the method includes the steps of:
installing the toolbar at the employer device,
authentication of the user,
using the selection tab to select at least a Job Report produced by the system,
generating by the system of a link associated with the Job Report, and
imbedding into a HTML code the link for display of the Job Report when a browser displays the HTML code with the embedded link.

13. The method of claim 12, including the step of allowing a job seeker to view the HTML code.
